(19) United States
(12) Patent Application Publication
(10) Pub. No.: US 2009/0228975 A1
(43) Pub. Date: Sep. 10, 2009

(54) METHODS, SYSTEMS AND COMPUTER PROGRAM PRODUCTS FOR CREATING SECURED ACCESS CODES VIA CONTINUOUS INFORMATION

(75) Inventor: Arnaud Lund, Cagnes-sur-mer (FR)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/257,446

(22) Filed: Oct. 24, 2008

(30) Foreign Application Priority Data
Mar. 6, 2008 (FR) EP08305049.2

(51) Int. Cl. G06F 21/00; G06F 3/048

(52) U.S. Cl. 726/16; 715/810

(57) ABSTRACT

Methods, systems and computer program products for creating secured access codes via continuous information. Exemplary embodiments include a method for generation of a secure access code, the method including retrieving a continuum of objects from a memory of a computer, presenting the continuum of objects on a computer display, storing a selected range from the continuum of objects in the memory, presenting a verification continuum of objects, storing a selected object from the verification continuum of objects in the memory, comparing the selected object from the verification continuum of objects to the selected range from the continuum of objects and in response to the selected object falling within the range of the continuum of objects, authenticating the access code.

This application claims priority to European Patent Application No. 08305049.2, filed 6 Mar. 2008, and all the benefits accruing therefrom under 35 U.S.C. §119, the contents of which in its entirety are herein incorporated by reference

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Field

This invention relates to secure access codes, and particularly to methods, systems and computer program products for creating secured access codes via continuous information.

2. Description

In conventional authentication systems based on access codes, the code is created by the user by choosing a sequence of discrete elements. Such elements are for example numbers in pin codes, letters/characters in passwords or pass phrases, in some implementation they can also be parts of images that are designated by the user.

### SUMMARY

Exemplary embodiments include a method for generation of a secure access code from a menu on the display, the method including retrieving a continuum of objects from a memory of a computer, presenting the continuum of objects on a computer display, receiving a menu selection entry signal indicative of the selection device pointing at a selected range from the continuum of objects, in response to the signal, storing the selected range from the continuum of objects in the memory, presenting a verification continuum of objects on the display, receiving a menu selection entry signal indicative of the selection device pointing at an object from the verification continuum of objects as a access code, in response to the signal, storing the selected object from the verification continuum of objects in the memory, comparing the selected object from the verification continuum of objects to the selected range from the continuum of objects; and in response to the selected object falling within the range of the continuum of objects, authenticating the access code.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, technically we have achieved a solution which, instead of using discrete information (such as numbers, letters or signs), the methods, systems and computer program products described here implement continuous information. The user therefore inputs access information that implements personal perception and appreciation, that is, something personal and related to the physiology/biology/history of the user, which is not easily reproduced.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fees.

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary embodiment of a system for creating secure access codes via continuous information;

FIG. 2A illustrates a flow chart for a method for creating secure access codes via continuous information in accordance with exemplary embodiments;

FIG. 2B illustrates a flowchart for a method for authenticating a user in accordance with exemplary embodiments;

FIG. 3 illustrates a color grid in accordance with exemplary embodiments;

FIG. 4 illustrates a color bar presented as a rainbow spectrum in accordance with exemplary embodiments;

FIG. 5 illustrates a color grid in accordance with exemplary embodiments;

FIG. 6 illustrates a color bar presented as a rainbow spectrum in accordance with exemplary embodiments;

FIG. 7 illustrates a target interface in accordance with exemplary embodiments; and

FIG. 8 illustrates a target interface having bullet hole entries in accordance with exemplary embodiments.

The detailed description explains the preferred embodiments of the invention, together with advantages and features, by way of example with reference to the drawings.

### DETAILED DESCRIPTION

Exemplary embodiments include methods systems and computer program products that present a set of objects to a user who perceives that the objects are continuous, as opposed to discrete as in conventional systems. In exemplary embodiments, an underlying framework selects discrete objects, which can be high in number such that the user perceives a continuum. For example, the user can be presented with a continuum of color (e.g., a rainbow). If asked to point out, “pale blue” the user may select one location while another user may select a separate location. However each user is able to say precisely where for the particular user, “pale blue” starts and ends. As such, if the user desires to use the color, pale blue, as a access code, when the user selects the access code for the first time, the user specifies to the system where the limits of pale blue are in the presented continuum (e.g., to position two cursors on the start and end of where the color, pale blue”, is for the user). Then the next time, to enter the access code, the user positions a cursor via a mouse, for example, within the limits that the user mentally visualizes the color pale blue, and clicks in order to enter the “access code”.

In exemplary embodiments, to increase security, the user can be presented several of colors (for example four colors). Thus, the access code that the user memorizes can be, for example, “pale green, bright orange, dark red, turquoise”. Even if an onlooker observes the user clicking the access code, the onlooker is only be able to perceive a general idea of the sequence of the access code (green, orange, red, blue) but not precisely enough to be able to recreate it the actual sequence. Currently, an onlooker can view a user typing a discrete password on a keyboard. An onlooker can have a better chance of seeing a discrete set of keys types rather than perceiving the same click sequence on a continuum of colors due to different perceptions of different people.

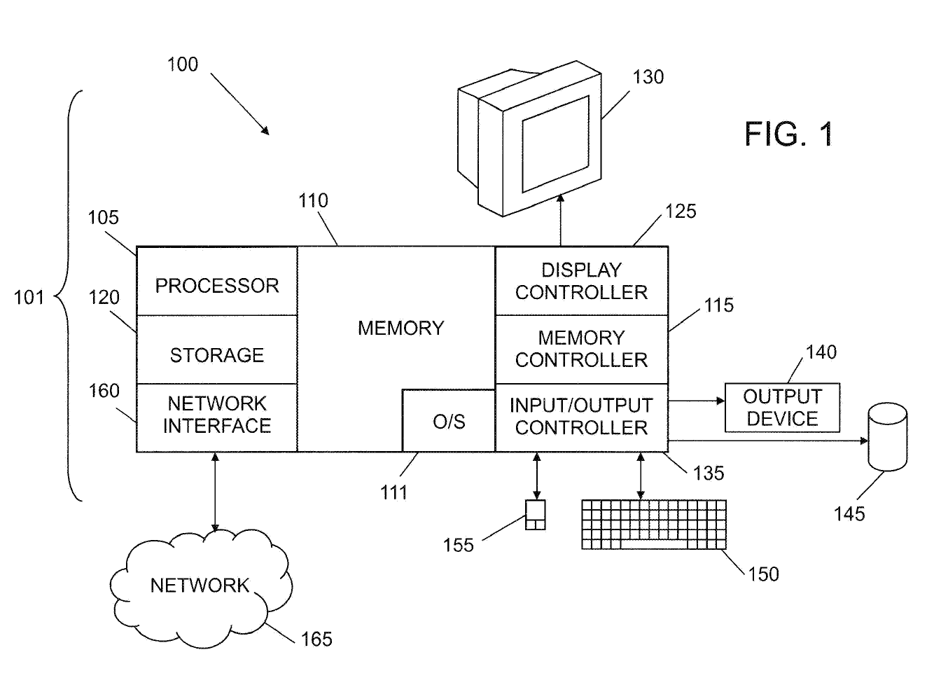

FIG. 1 illustrates an exemplary embodiment of a system 100 for creating secure access codes via continuous information. The methods described herein can be implemented in software (e.g., firmware), hardware, or a combination thereof In exemplary embodiments, the methods described herein are implemented in software, as an executable program, and is executed by a special or general-purpose digital computer, such as a personal computer, workstation, minicomputer, or mainframe computer. The system 100 therefore includes general-purpose computer 101.

In exemplary embodiments, in terms of hardware architecture, as shown in FIG. 1, the computer 101 includes a processor 105, memory 110 coupled to a memory controller 115, and one or more input and/or output (I/O) devices 140, 145 (or peripherals) that are communicatively coupled via a local input/output controller 135. The input/output controller 135 can be, for example but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing software instructions.

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The software in memory 110 may include one or more separate programs, each of which comprises an ordered listing of executable instructions for implementing logical functions. In the example of FIG. 1, the software in the memory 110 includes the continuous information access code creation methods described herein in accordance with exemplary embodiments and a suitable operating system (OS) 111. The operating system 111 essentially controls the execution of other computer programs, such continuous information access code creation systems and methods described herein, and provides scheduling, input-output control, file and data management, memory management, and communication control and related services.

The continuous information access code creation methods described herein may be in the form of a source program, executable program (object code), script, or any other entity comprising a set of instructions to be performed. When a source program, then the program needs to be translated via a compiler, assembler, interpreter, or the like, which may or may not be included within the memory 110, so as to operate properly in connection with the OS 111. Furthermore, the continuous information access code creation methods can be written as an object oriented programming language, which has classes of data and methods, or a procedure programming language, which has routines, subroutines, and/or functions.

In exemplary embodiments, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 100 can further include a display controller 125 coupled to a display 130. In exemplary embodiments, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In exemplary embodiments, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the software in the memory 110 may further include a basic input output system (BIOS) (omitted for simplicity). The BIOS is a set of essential software routines that initialize and test hardware at startup, start the OS 111, and support the transfer of data among the hardware devices. The BIOS is stored in ROM so that the BIOS can be executed when the computer 101 is activated.

When the computer 101 is in operation, the processor 105 is configured to execute software stored within the memory 110, to communicate data to and from the memory 110, and to generally control operations of the computer 101 pursuant to the software. The continuous information access code creation methods described herein and the OS 111, in whole or in part, but typically the latter, are read by the processor 105, perhaps buffered within the processor 105, and then executed.

When the systems and methods described herein are implemented in software, as is shown in FIG. 1, it the methods can be stored on any computer readable medium, such as storage 120, for use by or in connection with any computer related system or method. In the context of this document, a computer readable medium is an electronic, magnetic, optical, or other physical device or means that can contain or store a computer program for use by or in connection with a computer related system or method. The continuous information access code creation methods described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In exemplary embodiments, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In exemplary embodiments, where the continuous information access code creation methods are implemented in hardware, the continuous information access code creation methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Exemplary embodiments for entering a new code and setting of an access code are now discussed. In current systems, a code is a series of “object” designated by the user in sequences. The way of designation can vary. For example entering a pin code is usually done by pressing the corresponding keys. Pressing the key is the way to designate the corresponding number. Other current systems include the designation of the element with a mouse click. In all cases the “object” is selected and perfectly identified. The way the code is subsequently checked is the comparison that the selected objects sequence is identical to the sequences entered the first time, at access code definition.

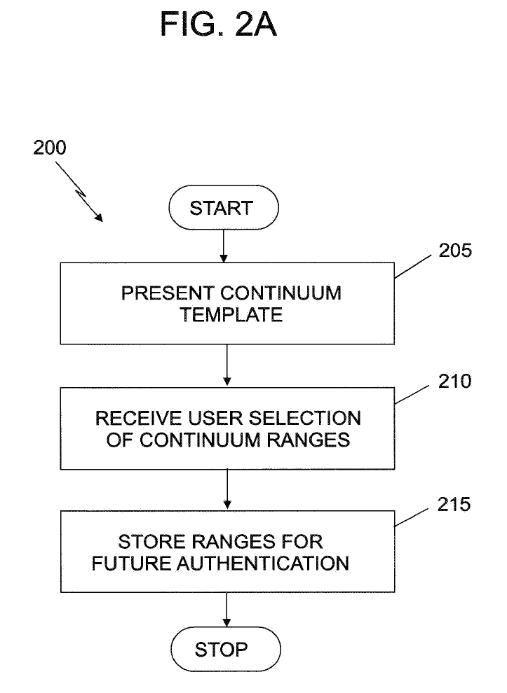

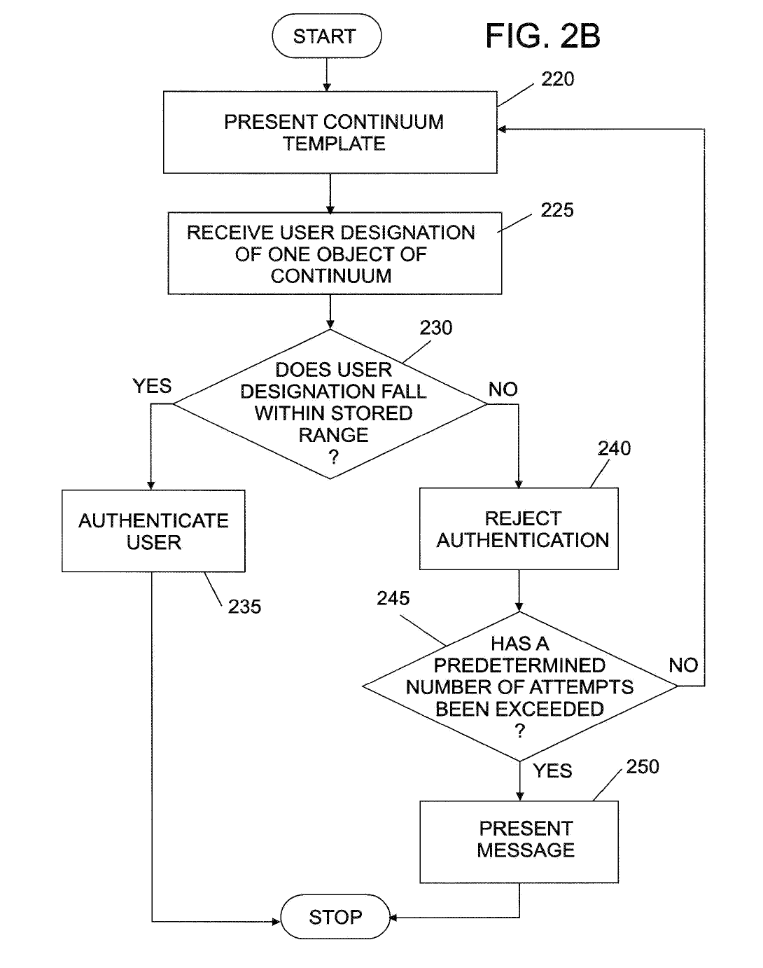

FIG. 2A illustrates a flow chart for a method 200 for creating secure access codes via continuous information in accordance with exemplary embodiments. In exemplary embodiments, when the user is presented with a continuity of objects the simple designation of current systems does not work, since there is little to no chance that the user designate twice exactly the same object, and even less a sequence of presented objects. In exemplary embodiments, to enter the code the first time when the user is presented with a continuum template at block 205, instead of designating a series of specific objects, the user designated a series of ranges. Each range can include two or more objects that are designated by the user and which constitutes the limits in between the “ideal” object that the user thinks and perceives is within the range that he user has selected. In one embodiment, the user can explicitly indicate those limit objects. In another embodiment, the user can enter the same code several times, and the system determines from these entries a valid range taking into account the variance of the user input. Either way, the system 100 receives the user selection of continuum ranges at block 210. At block 215, the system 100 stores the selected ranges for future authentication

FIG. 2B illustrates a flowchart for a method 201 for authenticating a user in accordance with exemplary embodiments. In exemplary embodiments, the user can then enter the code for verification when the proposed continuum is presented to the user at block 220. It is appreciated that the user can enter a code for verification once the access code is first entered similar to current systems in which a user is asked to enter and re-enter a password. It is further appreciated that the following description further applies to each time a user enters the access code. Once the code has been defined as described above, the checking of the code can include the user selecting a sequence of object from the proposed continuum, which the system receives at block 2225. Then the program verifies that each of the designated object falls into the corresponding range that has been define at access code creation at block 230. If the program has verified that the designated objects fall within the corresponding range that was stored at block 215, the user is authenticated at block 235. However, if the program does not verify that the designated objects fall within the corresponding range that was stored at block 215, the authentication is rejected at block 240. In exemplary embodiments, a predetermined number of attempts at authentication can also be stored. At block 245, the system 100 can check whether or not the predetermined number of attempts has been exceeded at block 245. If the predetermined number of attempts has been exceeded, then the user is given a failure message at block 250 and the flow ends. If the predetermined number of attempts has not been exceeded at block 245 then the user is presented with the continuum template again at block 220.

In exemplary embodiments, the user can also reset the access code. As in many current systems, the simplest way to reset a password is to implement the user mail box for authentication. In exemplary embodiments, when the user is prompted for the access code, the user is also proposed a “reset access code” option (e.g., a button). When the user presses the button a mail is sent to the user's mail box, which can include a URL. In exemplary embodiments, the URL points to a reset access code program and includes a string identifying the user and a string which has been randomly generated to ensure security. When the URL is accessed, a server program first checks that there is a reset access code request pending for this user and compares the randomly generated string to the one the server stored when the reset button was pressed. If the user is authenticated this way, then the user is offered an “enter a new access code ” like interface.

### EXAMPLES

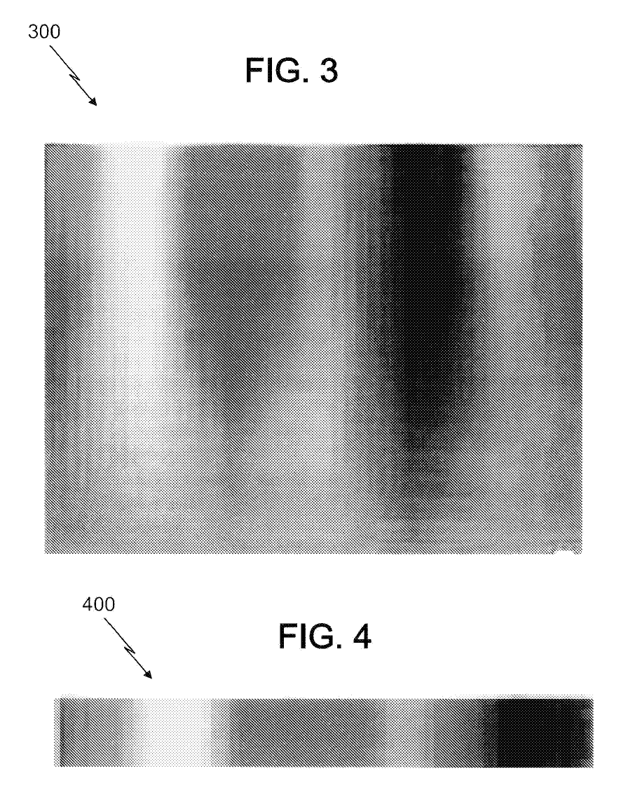

As described above, the system 100 can present a continuum template to the user for entry for the continuous information access code as described herein. For example, FIG. 3 illustrates a color grid 300 in which objects as described herein are colors. As described herein, the user can select colors and designated ranges from the color grid 300.

FIG. 4 illustrates a color bar 400 presented as a rainbow spectrum

Or in the form of a bar containing the whole rainbow spectrum,

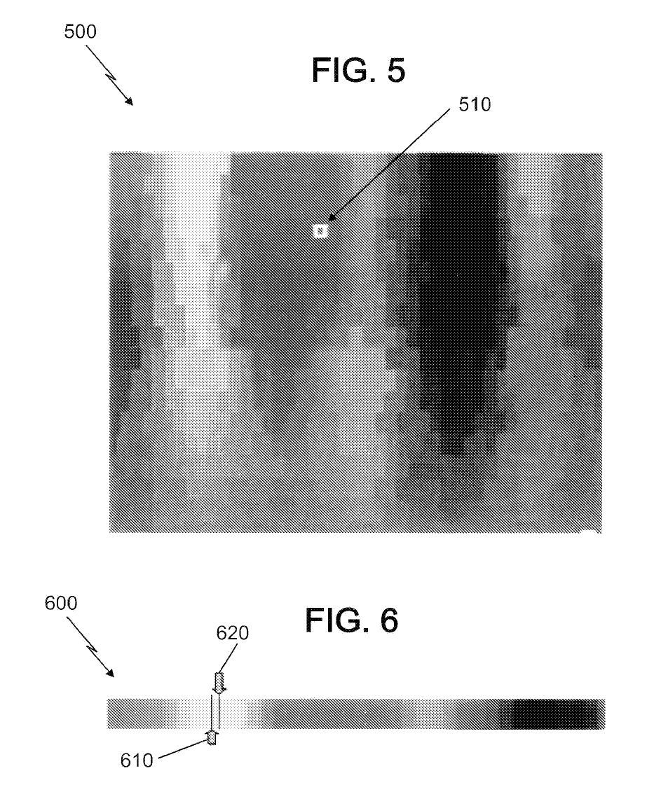

FIG. 5 illustrates a color grid 500 in accordance with exemplary embodiments. When entering a code, the user selects the range in which the chosen color is positioned. For example, the user selects with a selection device such as a mouse a square 510 in which the color is positioned.

FIG. 6 illustrates a color bar 600 presented as a rainbow spectrum in accordance with exemplary embodiments. In this example, the user can position two cursors 610, 620 to select an indicated range. When the access code is authenticated, the user can click on the chosen color. The program can then check to determine if the designated color is within the defined range as discussed herein.

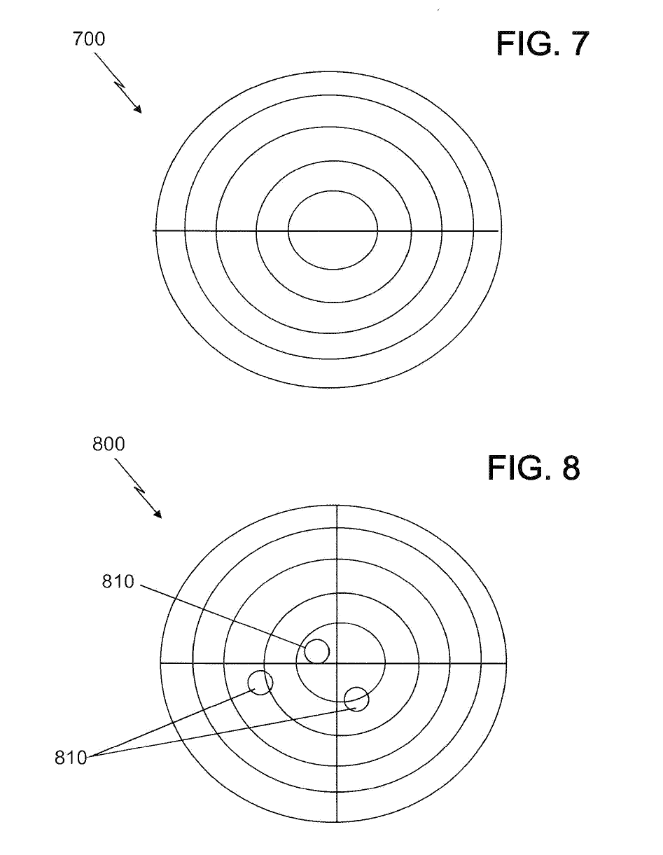

FIG. 7 illustrates a target interface 700 in accordance with exemplary embodiments. The interface 700 is in the form of a target. The user can place the selection device in locations on the interface 700 to place “bullet holes”. These designated objects (e.g., the bullet holes) are coordinates of the target (e.g., Cartesian coordinates). FIG. 8 illustrates a target interface 800 having bullet hole entries 810. For example, the system 100 can ask the user to enter the same code a series of times. The system 100 then determines variance and standard deviation on x and y axis designation for each element of the series and computes an appropriate range for access code verification range. For code entry for authentication, the user places the “bullet holes” 810 on the target, for example via the mouse (drag and drop). If all bullet holes are within the range defined at access code set-up, then the user is authenticated

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. In a computer system having a graphical user interface including a display, a selection device and a memory, a method for generation of a secure access code from a menu on the display, the method consisting of:
retrieving a continuum of objects from the memory;
presenting the continuum of objects on the display;
receiving a menu selection entry signal indicative of the selection device pointing at a selected range from the continuum of objects
in response to the signal, storing the selected range from the continuum of objects in the memory;
presenting a verification continuum of objects on the display;
receiving a menu selection entry signal indicative of the selection device pointing at an object from the verification continuum of objects as an access code;
in response to the signal, storing the selected object from the verification continuum of objects in the memory;
comparing the selected object from the verification continuum of objects to the selected range from the continuum of objects; and
in response to the selected object falling within the range of the continuum of objects, authenticating the access code.

2. The method as claimed in claim 1 further consisting of presenting a request on the display for entry of an additional range entry from the continuum of objects.

3. The method as claimed in claim 2 further consisting of:
receiving a menu selection entry signal indicative of the selection device pointing at an additional selected range from the continuum of objects; and
in response to the signal, storing the additional selected range from the continuum of objects in the memory.

4. The method as claimed in claim 3 further consisting of
comparing the selected object from the verification continuum of objects to the selected range from the additional continuum of objects; and
in response to the selected object falling within the range of the continuum of objects and within the range of the additional continuum of objects, authenticating the access code.

5. The method as claimed in claim 4 wherein the range of the continuum of objects and the range of the additional range of objects define the secure access code

6. The method as claimed in claim 5 further consisting of resetting the access code.

7. The method as claimed in claim 6 further comprising presenting a reset access code button on the display.

8. The method as claimed in claim 7 further consisting of:
receiving a menu selection entry signal indicative of the selection device pointing at an the reset access code button; and
in response to the signal:
generating a random string; and
sending an email message for presentation on the display, the email message including a URL for presentation on the display, the URL pointing to a reset access code program and including a string identifying the user and the randomly generated string.

9. The method as claimed in claim 8 further consisting of:
receiving a selection entry signal indicative of the selection device pointing at an the URL; and
determining that there is a reset access code request pending;
receiving a string entry; and
comparing the string entry to the randomly generated strong; and
in response to the string entry being equal to the randomly generated string, presenting a new continuum of objects on the display.
